(19) United States
(12) Patent Application Publication
(10) Pub. No.: US 2002/0109409 A1
(43) Pub. Date: Aug. 15, 2002

(54) Power energy distribution system controlling the distribution of energy

(76) Inventors: Otis H. Hastings, Mahwah, NJ (US); June C. Hastings, Mahwah, NJ (US)

Correspondence Address: Otis H. Hastings, June C. Hastings, 130 E. Crescent Ave, Mahwah, NJ, 07430, US

(21) Appl. No.: 09/779,942

(22) Filed: Feb. 9, 2001

(51) Int. Cl. H02J 9/00

(52) U.S. Cl. 307/64

(57) ABSTRACT

This is the method of controlling the distribution of energy. Energy can be in the form of electrical power, mechanical, hydraulic, gases, shielding from frequencies, communications, computers, liquids, solar energy and the like. Any form of energy that needs to be controlled and distributed. Whatever the requirement for a specific contact, the power energy distribution system, as it rotates from one contact point to another, distributes the specific requirement of energy without imposing a total demand load.

The control of the demand load to supply the needs of power is the invention.

### BACKGROUND OF THE INVENTION

1. Field of the Invention

The patents listed in the specification illustrate the energy requirements that can be controlled by the power energy distribution system but the power energy distribution system is not limited in use with these patents and includes use in any and all applications in the use of energy.

They include:

U.S. Pat. Nos. 4,121,523; 4,348,966; 4,381,716; 4,440,764; 4,475.465; 4,523,528; 4,587,712; 4,662,288; 4,748,915; 4,766,420; 4,773,338.

International Patent Nos. Canadian 1,054,860; 1,110,116; 1,128,371; 1,177,568; 1,197,765; United Kingdom Patent Nos. 2,003,223B, 2,087,472B, 2,087,473B, 2,087,474B;

French Patent No. 2,406,057; Belgium Patent No. 869,215;

Italy Patent No. 1,097,862; West Germany Patent Nos. P28 30 936.6-23; P28 57734.6; Australia Patent No. 560,871;

Japan Patent No. 1715141.

U.S. Pat. No. 5,344,696.

International Patent No. Canadian 2,074,487;

European Patent No. 0521003 issued in Austria; Belgium;

Denmark; Germany; France; Great Britain; Greece; Luxemborg; Netherlands; Spain; Sweden; Switzerland; and Italy.

U.S. Pat. Nos. 5,981,911; 5,966,501; 5,954,977; 6,018,141; 6,015,965; 5,932,124.

U.S. Pat. Nos. 4,879,320 and 4,965,296.

International Patent No. China 90102131; Australia; Barbados; Belgium; Denmark; Finland; France; Germany; Hungary; Italy; Japan; Monaco; Netherlands; Norway; Korea; Romania; Soviet Union; Sweden; Switzerland; United Kingdom; Canada; Mexico; Venezuela; Columbia; Argentina; Chile; New Zealand; India; Indonesia; Turkey; Ireland; Yugoslavia; South Africa; Taiwan; Singapore; Malaysia; Egypt; Kuwait; Saudia Arabia; UnitedArab Emirate; Qatar; Oman; Sri Lanka; Madagascar; Malair; Sudan; Luxemborg; Phillipines and Spain.

The invention is a power energy distribution system distributing energy. It can be electrical power, it can be fluids, it can be for shielding frequencies, it can be mechanical, or it can be for directing computers and communications, it can be for directing solar energy. The software that will drive the rotors has a central location of which the energy flows and then it rotates in a circle to different contact points which have a demand use for that energy. The invention is taking a center of a source of energy and then rotating it around to the point of contact on the rotor head to each contact point where the requirement has to be satisfied. If it is electrical energy, the electrical power coming into the center core of the power energy distribution system, will then, by computer, through a central source of tapping from one point to another to which the power energy distribution system can distribute the energy, thus being placed before it will open a valve, close a valve, turn on, turn off, or keep continuous speed that will have no interruption of power that is going to be delivered to each contact point. The use of the power energy distribution system from one application or need to another and the software in our FIG. No 1. identifies the center core of the power energy distribution system, then it being identified from a computer to designate the power to all different sections of the power use, or need, or requirement. FIG. No. 13 demonstrates a panel or a wing or a rudder or a blade requiring electrical energy to deice a section or an entirety of the section of a panel by the use of and being distributed by the power energy distribution system. Now we move into the different applications and the use of the power energy distribution system. It has a wide variety of applications that it can satisfy. What is the need? Why use the power energy distribution system? What is the invention?

The invention is taking one source of energy and distributing it into a center core with many-other needs of the same type of energy to satisfy its requirements or operations. The invention is that we take one need of the energy and we take a total requirement of what the power energy distribution system is going to service, and if we take just one example for the use of power to a certain requirement, whether it be to a panel board, whether it be to a breaker, whether it be to a direct motor, whether it be to light a certain area, the power energy distribution system will take the first amount of the highest amount of demand for that one contact and then it will rotate to the next source requirement and supply that amount of power or whatever the power requirement is from the center source to that particular contact, as the rotor rotates around the circumference of all of the contacts supplying the energy or the power to operate. This system will only use the amount of power that is required for the highest demand, self-regulate for the power as it goes from one contact to another. Now if we take the total demand of energy whether it is electrical power or whether it is fluid being directed from one source to another or whether it is for shielding or for operations of machinery, the demand would be prohibitive to turn them on all at once and operate such an operation with the cost of energy. The power energy distribution system can take that given amount of power and deliver it to each one of its requirements as it rotates around without putting a total demand load on the source.

So what we are stating, here is an example:

Take 8 contact points, take a total requirement, of those 8 contact points of 20 amps each, or a total of 160 amps to be delivered from the power energy distribution system. Now we have accomplished here is, we are putting 20 amps at say 110 volts in the center to the power energy distribution system to be distributed around 8 different points. Now, instead of having to have a prime load or statement of requirements of 160 amps, all we are delivering is 20 amps, 20 amps are visiting one of those contact points. Whatever area or revolutions Per minute that we rotate the center rotates to deliver those 20 amps to that contact point. The saving of energy and the efficiency of the use of the energy has now been demonstrated.

Now we take all of the other applications that we use the same example; then we use our computer that drives the power energy distribution system for all types of applications and for a higher number of contacts and for the higher RPM speed of the rotor rotating around to make its visit to each contact point to each demand load.

All of this can be regulated by the computer to deliver the amount of energy that is needed from one contact to another. In essence, we can almost regulate this at the speed of light, much faster than the speed of sound and we can take a tremendous requirement of power or energy and reduce it down to a minimum and the savings and the efficiencies and the cost of operating and manufacturing can be reduced by multi, multi times. This is the background of what the power energy distribution system can accomplish. The need for this power energy distribution system is evident in the communications industry where the need for constant power, back-up power (UPS) and for air conditioning is apparent. See article attached, entitled” “Eye on the Street, Uninterruptible Power is the priority to e-world”.

2. Description of Prior Art

We have had many different types of voltage regulators, different types of transformers and different methods of transmitting energy, electrical power, fluids, gases, shielding, communications, computers, operating equipment, operating robots, or solar energy.

There is no art, to my knowledge, that can take a given amount of energy and distributing it from one point to another without having a demand load and distributing it.

This invention is so energy saving and so cost saving in respect to the simplicity of its invention of taking a given source and distributing amongst many requirements without having a demand load to do it. Thus, prior art that has been used does not come into any consideration with the efficiencies and the operation and the unique method of being able to control and distribute and being able to be efficient and being able to make cost savings and much more efficiency of using energy than the devices that can be used to regulate the entire operation of a home, of a factory, an aircraft, any type of transportation, communications, computers and solar energy with the highest abilities to maintain constant energy sources shielding of all different types of frequencies and giving economies to its use for all different patents that we hold.

A list of patents that we hold can form a part of this prior art and now use of this invention to implement all of these patents that we are identifying, all of these source requirements we are identifying, also with the computer and the software that can drive all different types of applications of the power energy distribution system.

We must use, with the power energy distribution system, a computer which is on a timely on-line system which operates the power energy distribution system for whatever operations it is being programmed to accomplish or a multiple of applications to which it is programmed. One computer can possibly drive several different power energy distribution systems, perhaps just one. So it has many efficiencies it has much potential and all types of energy savings, safety, fire prevention, of which is in our patents, all different types of environmental control which is in our patents, this ties in the whole network of all of the accomplishments in our careers in developing new technology.

This is our knowledge of the prior art.

The software directing the power supply to the computer and then to the power energy distribution system will be different depending on the size of the power energy distribution system and the amount of energy that is required to operate the system.

Therefore, the software/computer system to be used in conjunction with the power energy distribution system will vary depending on the statement of requirements of using the power energy distribution system.

The power energy distribution system is the invention.

### BRIEF SUMMARY OF THE INVENTION

This invention provides the technology and the ability to take energy, a total demand of energy and take the need for each part of that total, total demand of energy and deliver it to each one of its requirements of its rotating around the source of energy which is around the center core, which is the power energy distribution system's contact. In simplicity, the center core can be driven by a total requirement for each contact point, not a total demand load, always keep that fact as the invention. The invention takes whatever is demanded in its rotation from one contact to another by the use of a center core rotator, rotating from the center core of energy coming into the center rotation and delivering it to a contact point, the contact point which it passes in its rotation. Now we have a summary of the basic invention. Now the basic invention is so flexible for its efficiencies in delivering energy from one location to another. It can be operated by a computer to deliver from many, many sources, requirements that demand a variable amount of power from one source to another without putting a demand load on the total to do all of the feats this rotation can accomplish. This rotation can accomplish from point A, B, to C. Point A can have a demand load of x amount of energy, B can have another amount, point C would have another amount and that the total amount of A, B, and C. would be demanded to operate the system. Only the power of energy to satisfy that need would be delivered to that point of requirement. As it rotates, the faster it rotates, the less interruption of being able to accomplish the total demand load for a fraction of the cost of energy or operations or efficiencies of their costs. Therefore, this summary of what can be accomplished by the use of this invention has multiple points of which can be adopted for all different types of operations; whether it is for commercial, whether it is for industrial, whether it is for all types of transportation, roads, bridges, runways, for homes, communications, solar energy, computers, all types of energy are subjected to the great advantage of this invention.

Wherever uninterruptible power is required, it can be tied in to this power source to the rotor, can be timed so if there is a requirement for no interruption, the UPS (Uninterruptible Power System) can keep the power on until the next visit and will not lose any efficiencies without any interruptions. Simultaneously, in all of our patents listed in the specification, there would be a need and a requirement for the power energy distribution system, we list all of the patents, of the technologies and the uses of this invention.

### A BRIEF DESCRIPTION OF THE DRAWINGS

FIGS. 1 to 16 illustrate the use of the power energy distribution system in all the applications and patents, but not limited to, in the claims 1 to 31.

### DETAILED DESCRIPTION OF THE PREFERRED EMBODIMENT

A complete explanation of how the power energy distribution system works. The power energy distribution system works with a controller, controlling the energy to be delivered into the center core rotor for the distribution of energy to the different locations. Now, the total demand of these different locations and their energy need is what is being transmitted to the controller, the controller source coming into the power energy distribution system. The power energy distribution system distributes energy for each requirement as it rotates around its orbit. Its orbit can be many areas of which it contacts the rotor head which transmits energy. To make this example very simple, we state this is how it operates.

1. We have a source of energy

2. We have a demand for energy

3. We have a total demand if all of the energy on these requirements are demanded at the same time. The invention is that it takes one demand of energy and takes it through the controller, controlling the energy is the power energy distribution system and delivers it to each of the demand of energy which would be from a central source to a distribution source to a panel board, whatever. The power energy distribution system takes that simple source of energy for that single source and delivers it in a clockwise rotation with a rotor and with a contact point that points to each visit to each contact for its demand. This demand will be met as it rotates and the speed of rotation provides the time of interruption from one point to another. If there is an uninterruptible power demand, any one of these contacts going to satisfy a requirement of energy is required that a back-up system will maintain that energy until the next visit of the rotor for that single source and delivers it in a clockwise rotation with a rotor and with a contact point that points to each visit to each contact for its demand. This demand will be met as it rotates and the speed of rotation provides the time of interruption from one point to another. If there is an uninterruptible power demand, any one of these contacts going to satisfy a requirement of energy is required that a back-up system will maintain that energy until the next visit of the rotor rotating around in a clockwise rotation, visiting each contact point for each requirement is only going to be controlled by the highest demand of its requirement to the controller and that is the amount of energy that is going to be transmitted from the source to the rotor and to each individual requirement and the speed of rotation and the amount of energy and the uninterruptable requirement is all in the embodiment and the control system and the distribution of energy.

That is the invention.

Illustration of the Invention

The power source comes to a meter. The meter which has the power supply coming into the breaker, the breaker can shut off the power for any reason but will allow the power to go to the power energy distribution system.

Illustration.

If the power source is 110 volts and 100 amps, whatever, the requirement is on the power energy distribution system of the circuits. Now the power coming from the main breaker for distribution from the power energy distribution system has the source of power from the breakers and that is 110 volts, 20 amps which is the size of the breakers to be distributed. All that is to be assigned or distributed to the power energy distribution system which is 110 volts and 20 amps that would be what would be required for one circuit.

We are only going to take 1 breaker that requires 110 volts and 20 amps to operate the circuit. Now the power energy distributor is between that one circuit and any other circuit that has the same requirement and only this amount of power going into the power energy distribution system for distribution to the other circuits or other breakers.

This is the second part of the invention, as illustration:

Showing that the source of power from one breaker is now being distributed among the other breakers in the panel. The statement of requirements, the number of breakers, can multiply or decrease. The amount of power will never change from the amount of power from one breaker which is 110 volts and 20 amps. Now a total requirement to put all of the breakers on for a total demand load will now be distributed one circuit to another from the power energy distribution system. This power will spin around at different revolutions per minute depending upon the demand for the circuits, case in point:

Illustration:

If only 1 or 2 circuits are requiring power, the speed of the rotor will increase the same amount of power by demand to the variable speed motor for the speed of the rotor, it will speed up so that the intervals of one circuit or breaker is so fast, one source of power will be distributed to all of the requirements of the breakers and circuits so there will not be any interval time delay between-one to another. If a critical power requirement is required in this system, than a UPS will be available to support uninterruptible power to each circuit requiring constant power. However, this illustration is to clarify and to establish this invention so that one source of power, one demand load can be distributed among many circuits having the same voltage and amp requirements.

This system can be expanded so if one demand load is different from another,

Illustration:

1 breaker requires 10 amps, another breaker requires 50 or 100 amps, then the microprocessor or controller will now have available for a Dower energy distribution system at that point to take from the power source, the amount of power to satisfy that demand.

These are the illustrations of this invention. Many different sources of power can be supplied and controlled by the power energy distribution system. Also to expand from the use of electrical power, this same power energy distribution system can be used for different types of energy requirements and can be used for different types of energy, such as fluids, solids, gases, communications, computer, solar energy, frequencies. All different types of operations, manufacturing and industries in that the power energy distribution system can decrease use as well as cost of energy dramatically and operate systems on-line and with uninterruptible power.

[image]

What is claimed:

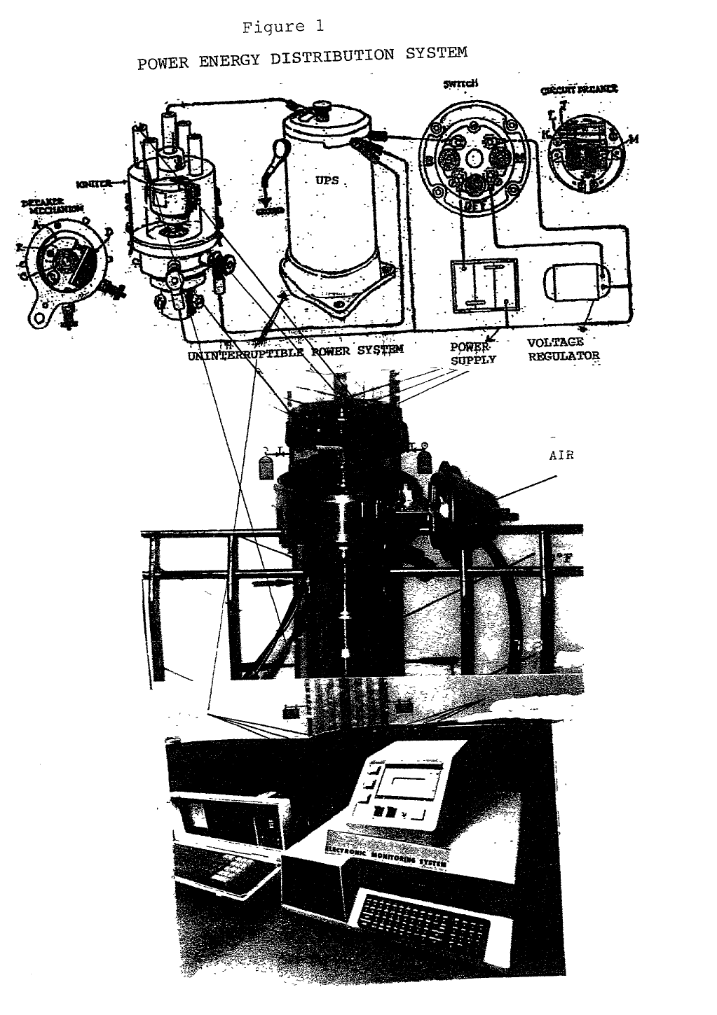

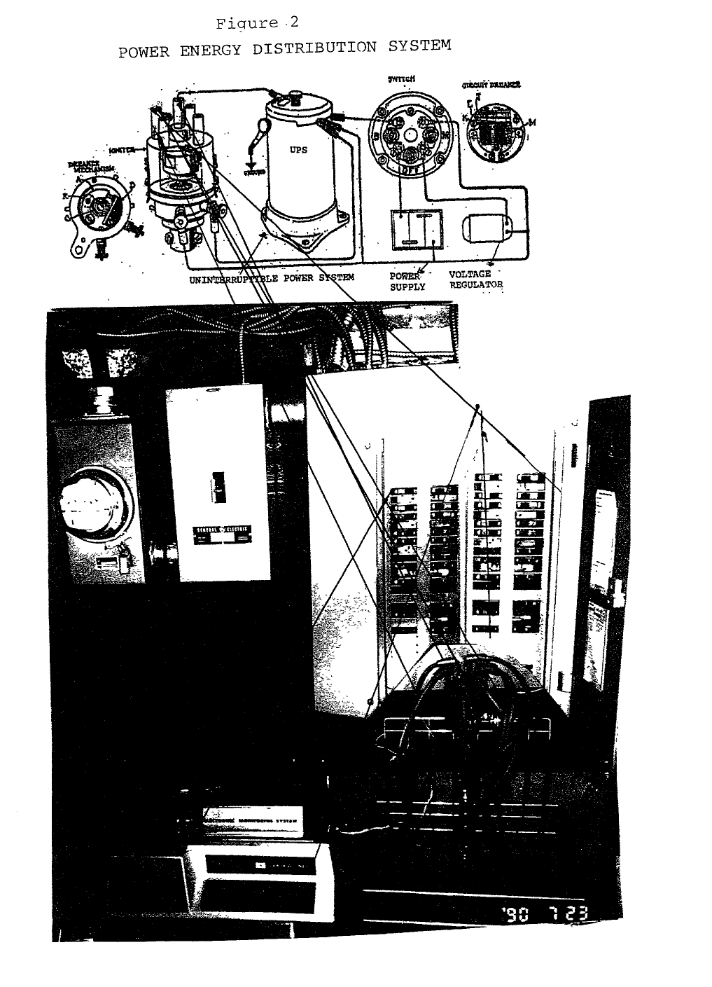

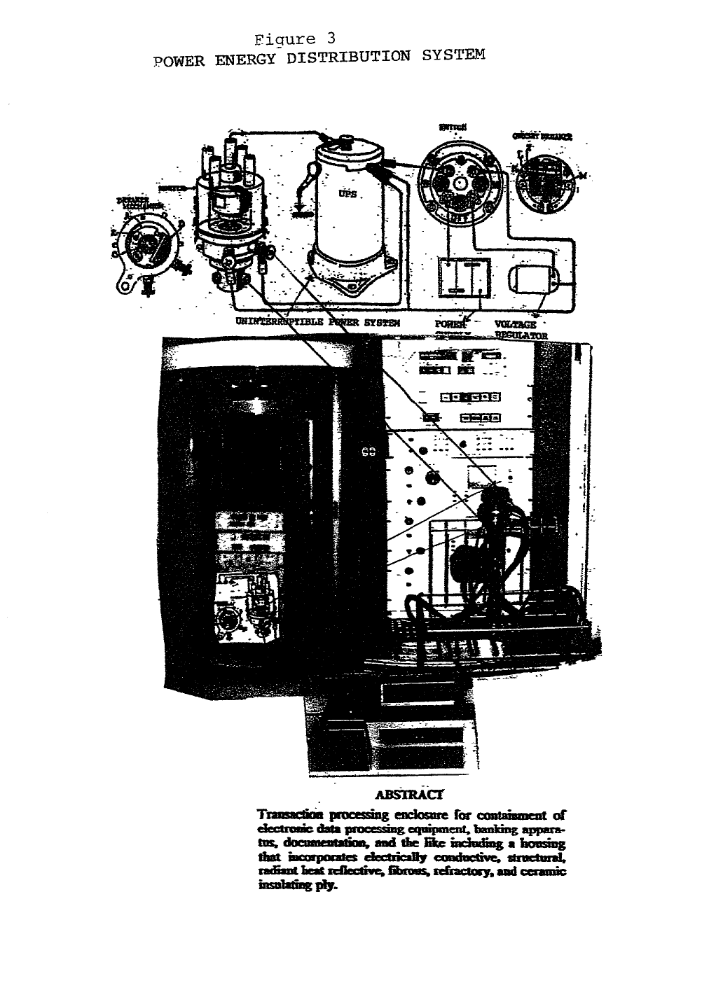

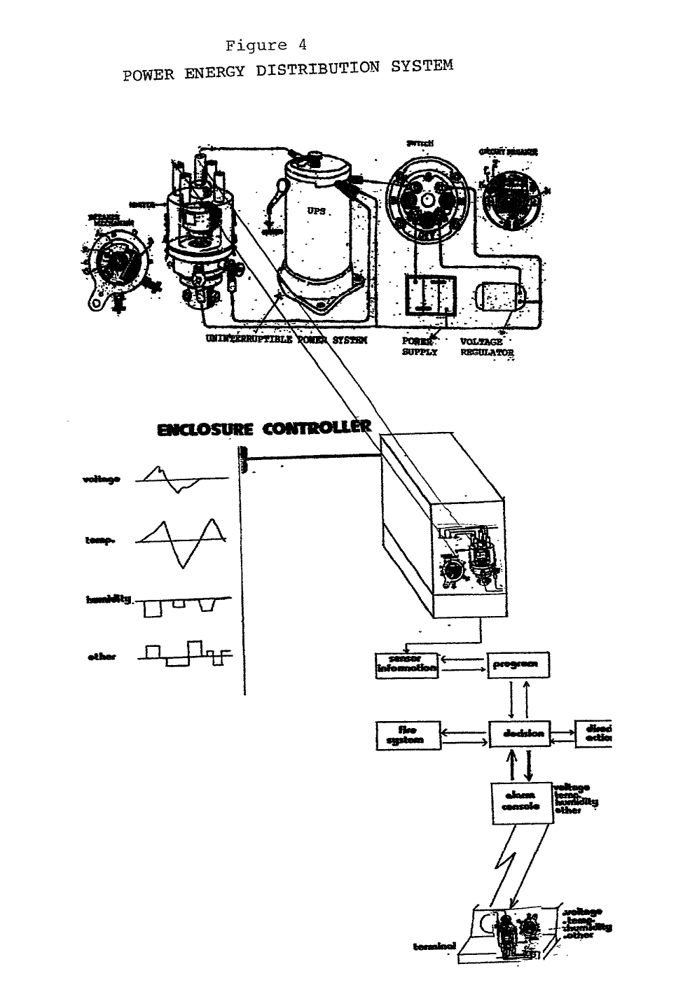

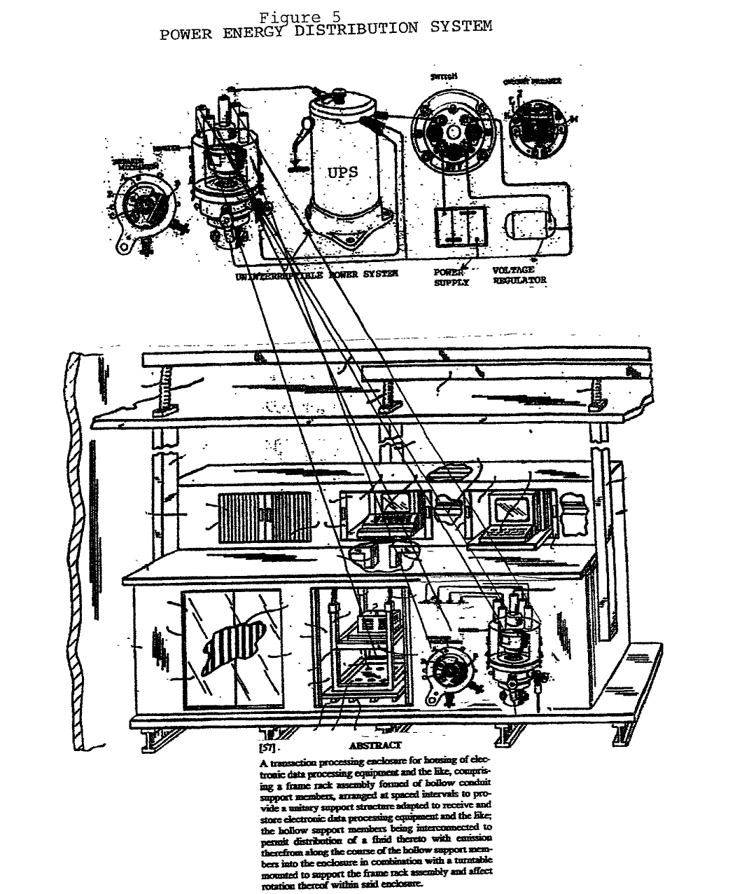

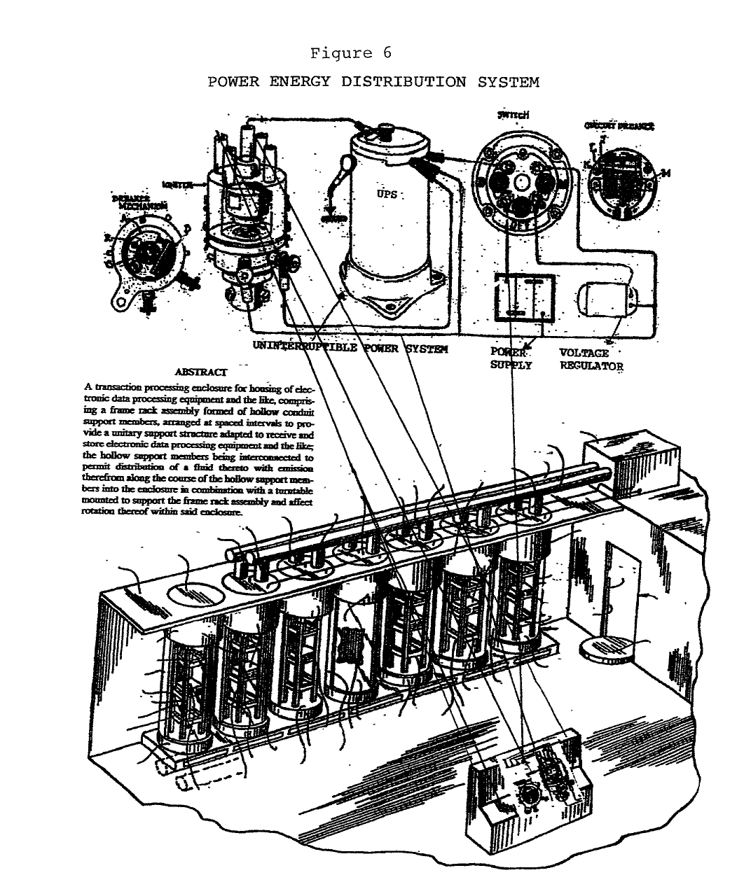

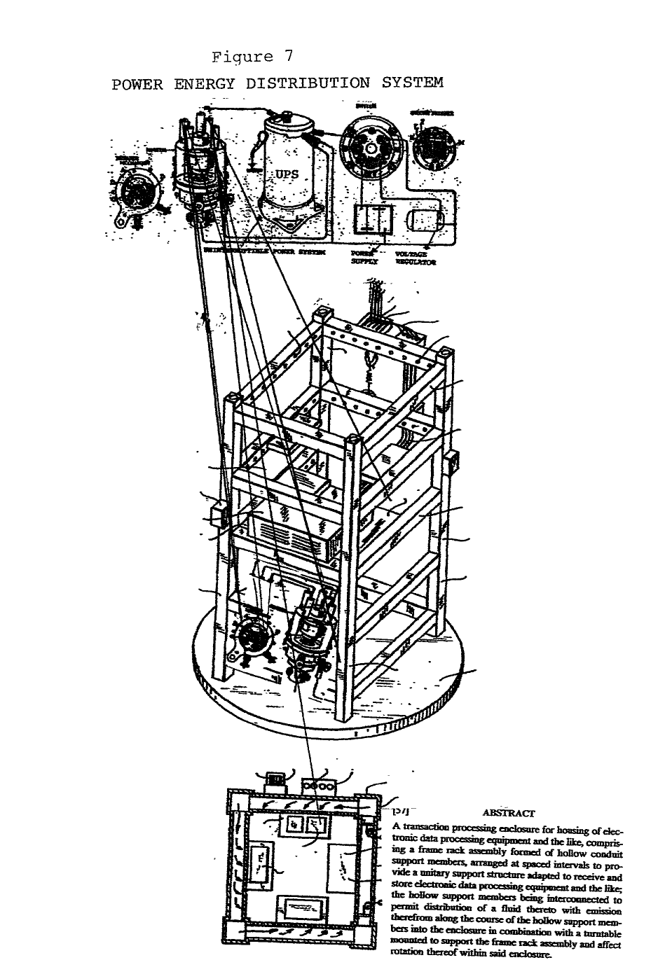

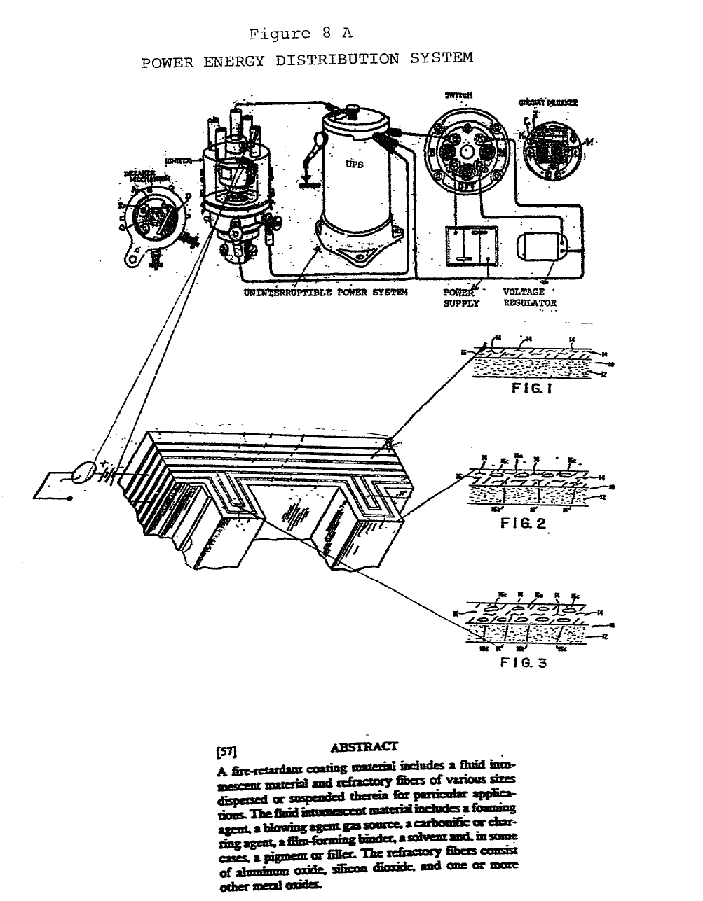

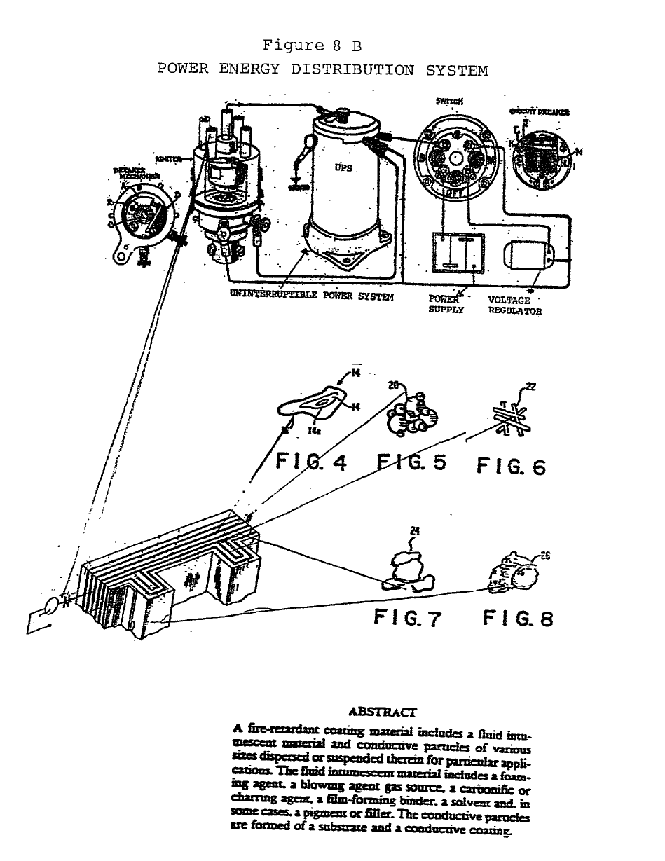

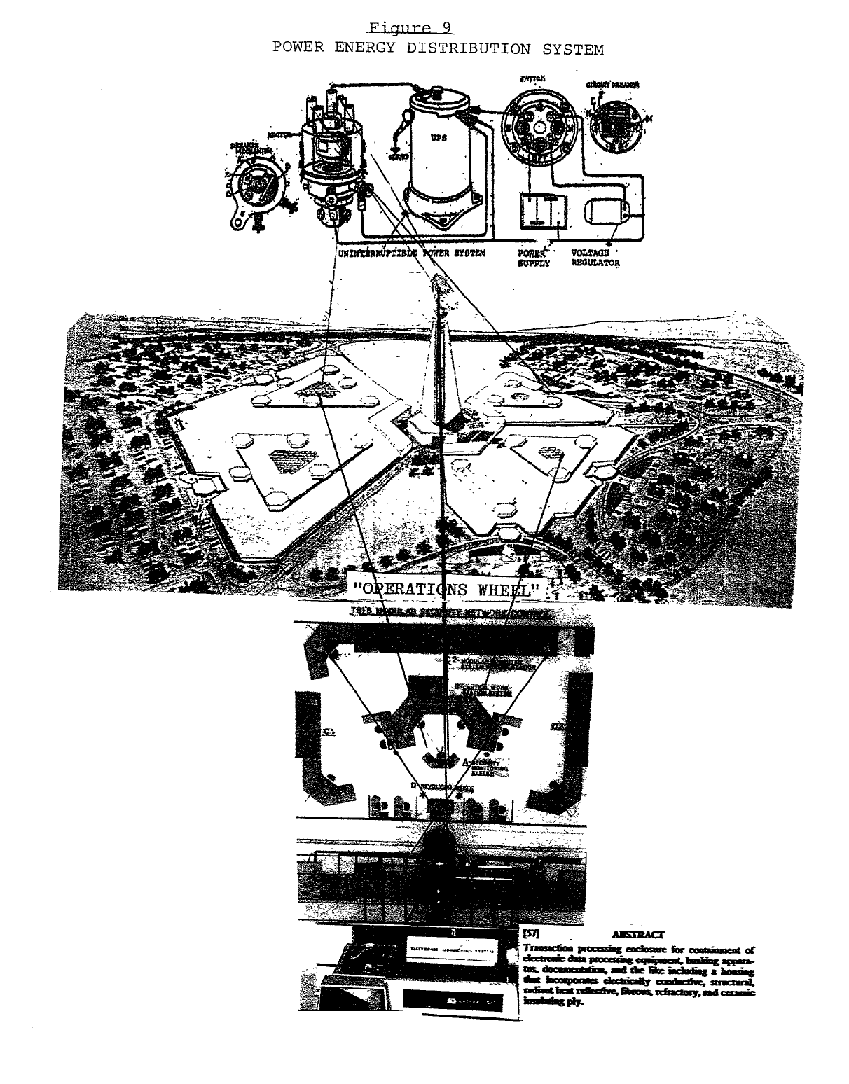

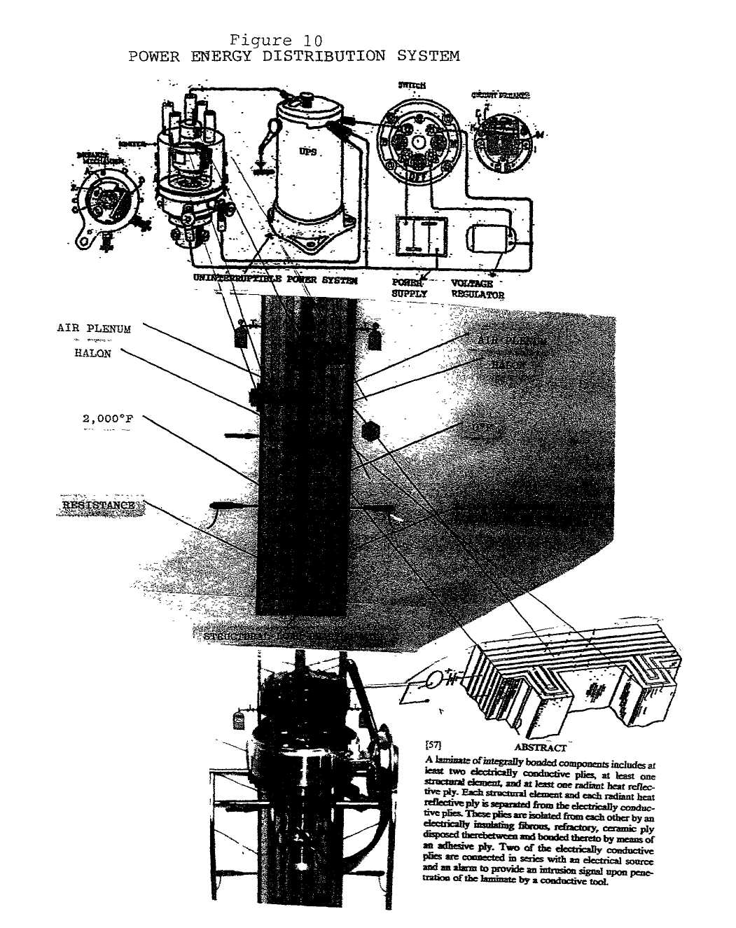

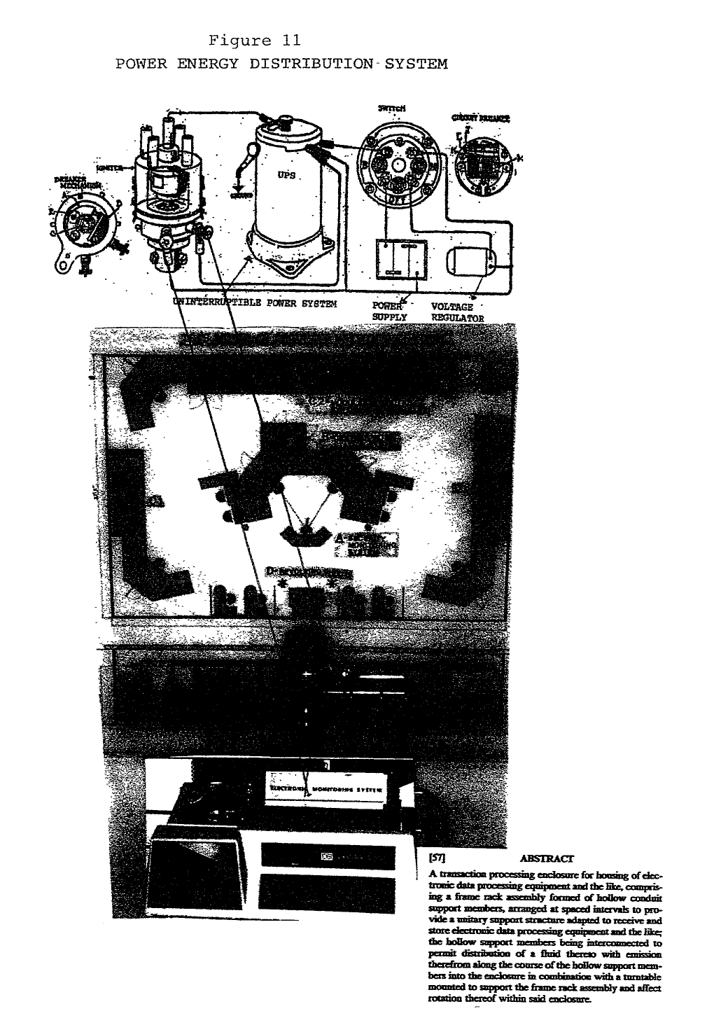

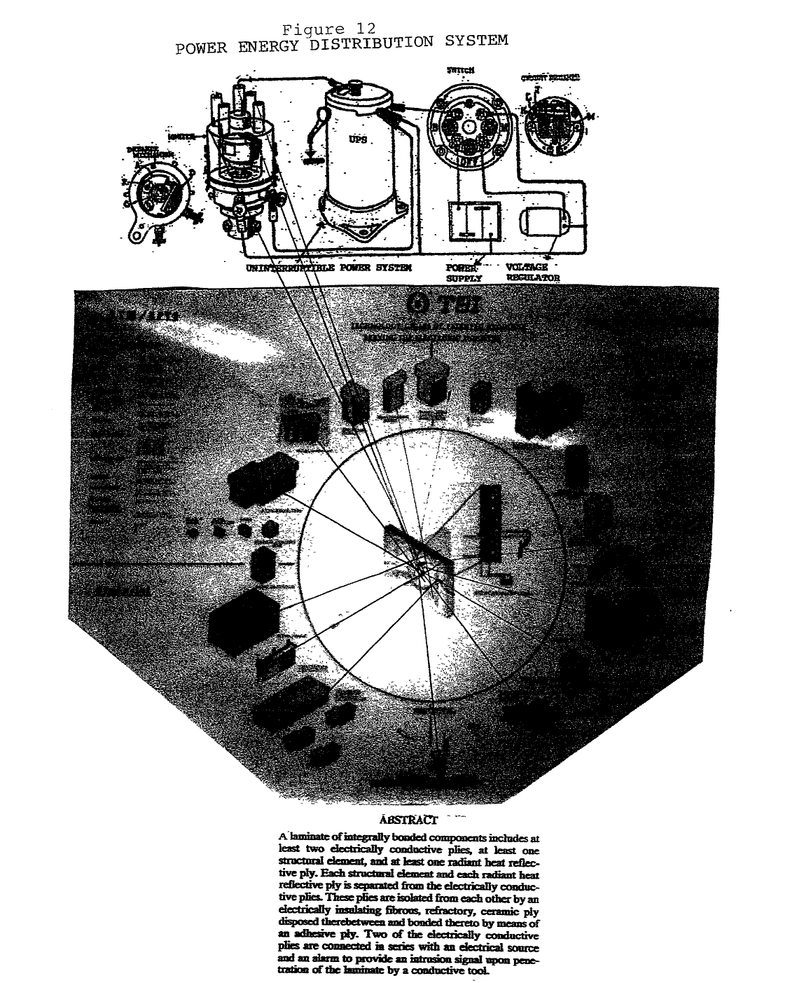

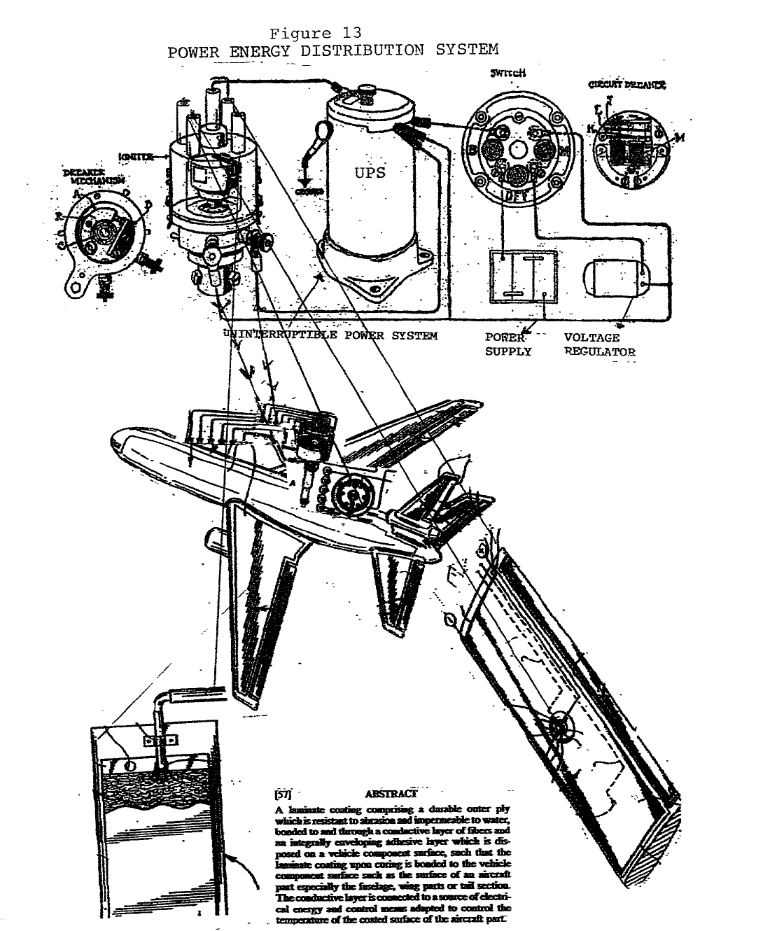

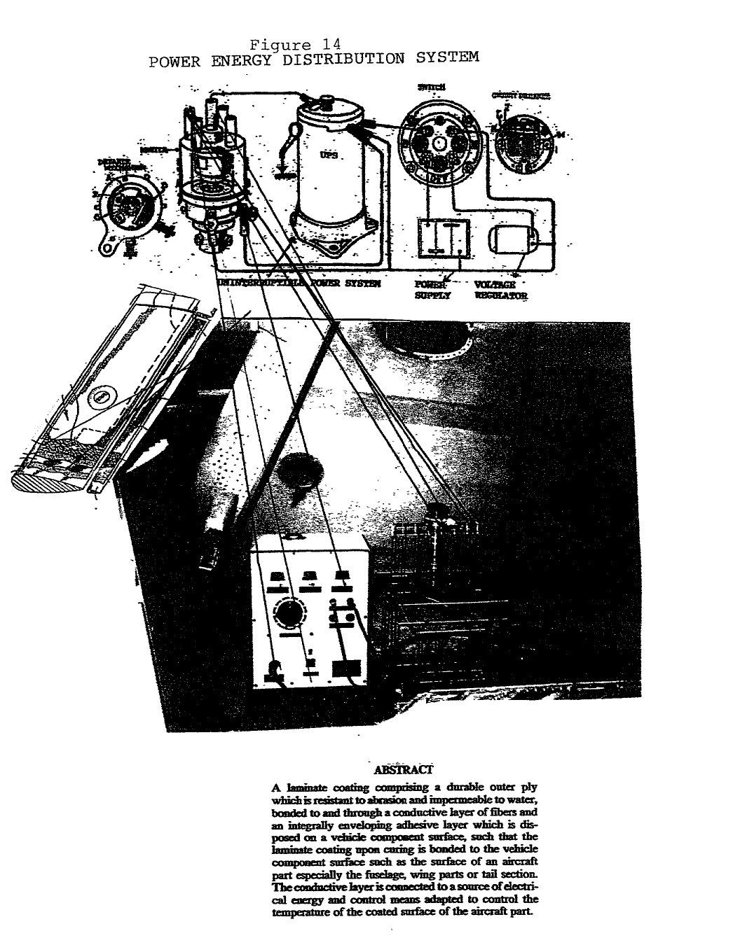

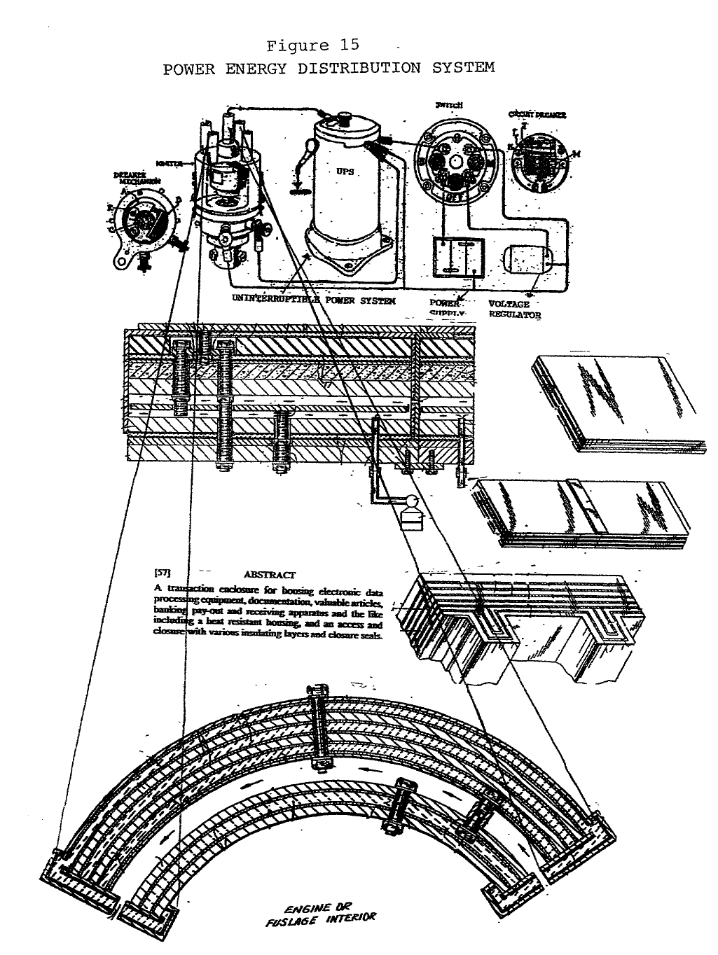

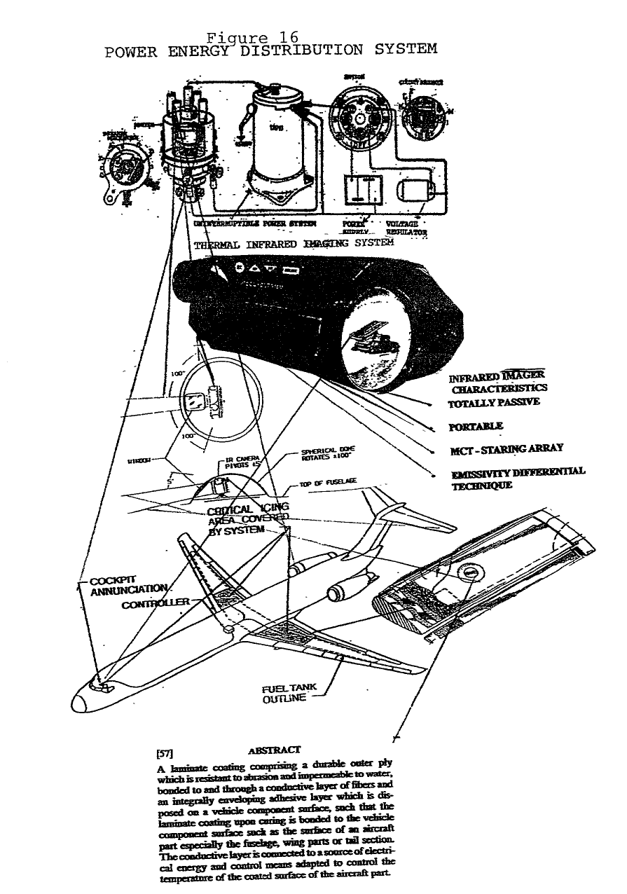

1. Claim 1 claims an invention to control and direct energy from a central point to a distribution point via the use of a power energy distribution system which is operated by a source controller directing power to a power energy distribution system which rotates in a circle and is a contact point which contacts each source of power requirement which the power controller directs to the power energy distribution system that rotates from one demand load or contact point to another around a circle, the invention is that the demand load for a series of any 8 or 10 points or many more in a circle can contact from the center rotor contacting to each point, each point of the center rotor contacts or delivers the power to that requirement from the power energy distribution system; now the controller is a point which is automated and controlled that the power coming to it is the amount of power that would be required for each circuit; the invention is that the power requirement for that specific circuit or energy or whatever rotation to satisfy the use of energy from the controller will satisfy that requirement; the invention also includes the fact that only one of the sources of energy coming from the power controller to the power energy distribution system is going to be used to contact all of the other requirements, the invention is that we take one requirement of energy and distribute it on a rotation of many different points and uses of energy therefore instead of having a demand load from the power controller or source controller we are using only 1 requirement to rotate, contact all of the other requirements; so we have taken one demand load and we have distributed the demand load of all the other demand of power or other sources of power or energy say from 1 to 10, therefore as the rotor rotates, the rotor is rotated to each demand contact point we have diminished 1 times, times whatever times the demand load is required in the rotation; this could be from 1 to 10, 1 to 100 whatever, the speed of the rotation the RPM, the faster it moves from one to another taking away the interruption also in the power control system it has an uninterruptible power system so that when the rotor leaves one point of contact to another the UPS will supply that demand from its storage and will be recharged as the rotor goes from one contact to another, the faster it goes, the less interruption and the UPS will store energy while the rest of the demand load on the rotor going from one to another will restore itself and if there isn't enough source of power to take the power demand say all 10 points, all 8 points demand load immediately as the rotation goes around the rotar takes power from the UPS to supply the UPS for that particular source; we will then take power from another source, a utility or solar system so what we have here is a total backup system and the faster the rotor moves in its orbit, the faster the energy is dispersed and we can reach very high speeds so that one source of power can supply multiple requirements of the same need or more and tap into a UPS system, now we have taken in this invention and described that one source of power that is brought to the power control system which provides the power to the power energy distribution system, it is all programmed on a microprocessor system and a UPS system which can be used for electrical power distribution, for fluids, for gases, for all different applications where energy has to be used and distributed; it enables energy savings and cost savings; this invention will implement said patents referred to in the specification, but not limited to, and will be used for all applications for all applications of the requirements of energy use; refer to FIGS. 1 to 16;

2. Claim 2, wherein in claim 1 we describe the power energy distribution system, claim 2 describes how the implementation of claim 1 developes the control of energy distribution; claim 1 describes all of the implementation of the invention to be used for all different applications and claim 2 describes the housing of the power energy distribution system which controls and distributes energy from one point to another or one requirement to another; Refer to FIGS. 1 to 16;

3. Claim 3 is describing claim 1 and 2 and the implementation of the invention and its protection to supply and provide all of the claims that will follow hereafter; first we refer to patents that provide an enclosure for the implementation and utilization of the power energy distribution system; Refer to FIGS. 1 to 16;

4. Claim 4, as in claim 1, 2 and 3 describes the environmental enclosure with the patented applications for the use of the power energy distribution system providing the proper environment and the protection and utilization of the power energy distribution system; each claim will describe how the invention performs and why; Refer to FIGS. 1 to 16;

5. Claim 5, as described in claims 1, 2, 3, and 4 claims how energy that is being brought into the power energy distribution system is controlled; it is an environment that ensures the sophistication of the use of energy or whatever source of energy is required to be protected against different types of interference and outside environmental interference so in that the system is shielded from radiation and frequency interference; Refer to FIGS. 1 to 16;

6. Claim 6, as in claim 1, 2, 3, 4, and 5 outlines the requirements to use and operate the power energy distribution system; refer to FIGS. 1 to 16;

7. Claim 7, as in claims 1, 2, 3, 4, 5, and 6 describes the power supply that comes to the controller which provides the power to operate the power energy distribution system and its requirements; the power surge can come from different sources and this now develops another independent claim wherein power or energy or fluids or gases, or radiation shielding whatever the power energy distribution system is going to be utilized and operated, in has this protection for this type of operation and also for a source of energy to which may be solar, it may be high velocity, may be forces of gases through space or light passing through space and used in the art of this invention; refer to FIGS. 1 to 16;

8. Claim 8, as in claim 1, 2, 3, 4, 5, 6, and 7 wherein this claim implements all of the description of the first 7 claims; this claim 8 starts the use of the invention for different applications; in claim 8 wherein the knowledge of this invention is being implemented, it can now be used for the distribution of electrical power, electrical power is a wide use of energy for many applications; in claim 8 wherein the knowledge of this invention is being implemented it can be used for the distribution of electrical power, electrical power is a wide use of energy for many applications wherein this invention with its ability to fulfill all uses of electrical energy for a fraction of the cost to provide for all types of electrical requirements because it is electrically controlled, it is an uninterruptible power source that can be multiplied by many multiplications by increasing the speed of the rotor from a single source to a demand source and can lessen the requirements of the UPS system and can conserve energy and natural energy resources; refer to FIGS. 1 to 16;

9. Claim 9 is an independent claim that takes the first eight claims and puts it into an operational center that can operate with all the uses of the patents that we have outlined from an individual installation to a master system that can control all different types of energy from one requirement to another, both on earth and in space, we have developed the system of conservation of the use of energy enabling energy savings and cost savings in all of the patents referred to in the specification but not limited to, for use in aerospace, aircraft, transportation, building construction and residential, roads, bridges, fire resistivity, fire protection, and radiation protection and the utilization of the isolation of one source of energy from another and controlling it on the inner and outer surface, all electronically controlled; refer to FIGS. 1 to 16;

10. Claim 10, as in claim 9 claims the use of solar energy or the use of fluids, such as water force, air force, can also be controlled by a shielded power energy distribution system so that it does not dissipate its advantage in places where the requirement is needed; differentials in temperature can be controlled by the power energy distribution system for the use of the enclosures described in claims 2 and 3 and how they perform in the area of transportation, the system can be used for fire protection in aircraft, all types of transportation, not only does the power energy distribution system micro-processor perform for one use but for multiple uses, using the different energies that we use with the power energy distribution system using all of the inventions, patents and technologies to this point and now using it for controlling the environment, controlling the use of liquids, controlling the use of gases, controlling the use of electronics, electrical, mechanical and all different types of energy that can be imposed, cam now be detected and shielded and distributed; refer to FIGS. 1 to 16;

11. Claim 11, as described in claim 8 identifies the protection and utilization of the conservation and use of the power energy distribution system, now the power energy distribution system incorporates the use of all of the technology that has been developed and patented but not limited to these patents referred to in the specification; refer to FIGS. 1 to 16;

12. Claim 12 is an independent claim which claims the use of the power energy distribution system with all these different patents referred to in the specifications but not limited to that are identified in this claim for fire resistivity for shielding, for energy dissipation, for radiation shielding, for isolation, for frequency distribution and frequency shielding, enabling energy savings and cost savings; refer to FIGS. 1 to 16;

13. Claim 13, as described in claim 12 wherein we take the power energy distribution system (the invention) as described and claim it for different applications which require energy, isolation, distribution of temperature, humidity, to operate in the prescribed atmosphere that controls the operation and requirements of the power energy distribution system; refer to FIGS. 1 to 16;

14. Claim 14, as claimed in claim 13 is the use of this invention for aerospace, fire protection, structural integrity, prevention of environmental problems such as de-icing, and environmental control within the structure of the aircraft, wings and vertical stabilizer, which includes aerospace, space ships. etc. wherein shielding dissipation can kick off radiation is all involved in this invention; refer to FIGS. 1 to 16;

15. Claim 15, as in claim 12 is the use of the power energy distribution system for industrial use in manufacturing, for robotic control, and all different types of equipment and material which have to be developed to meet certain requirements that this invention can implement, support, develop and improve the quality of the product, production of the product and the safety of the individuals who are involved in this manufacturing-reduced cost; refer to FIGS. 1 to 16;

16. Claim 16, as in claim 12 is the use of the power energy distribution system for residential housing, all different types of facilities, hospitals, different types of environmental control for recuperation, radiation control wherein the energy is required to be cleansed, controlled from said patents listed in the specification but not limited to that can implement and provide all necessary requirements for the power energy distribution system to perform, including schools, hotels, office and public buildings; refer to FIGS. 1 to 16;

17. Claim 17, as in claim 12 is the power energy distribution system that has the ability to isolate, insulate and direct energy through a laminated panel, being able to conserve energy and shield energy to create a controlled fire resistant environment; refer to FIGS. 1 to 16;

18. Claim 18, as in claim 12 there are many requirements for the power energy distribution system for all different types of professional use in the medical field, field of physics, in the field of electronics, in the field of uses of energy to protect a source of energy from another source of energy is just a start of what can be controlled by the power energy distribution system and said patents listed in the specifications but not limited to these patents; refer to FIGS. 1 to 16;

19. Claim 19 as in claim 12 in the field of fire resistivity, coating the different vessels or housing with our fire resistant material both conductive and nonconductive wherein we can conduct, if heat is being imposed and the fire resistivity will provide the proper protection or else it will kick in additional support through the communication system, the communication system as we see it today in the implementation of the power energy distribution system with the patents to protect, shield and direct communications and especially is the electronic industry. in the computers, to which we have the patents to protect the system for its operation and utilization but not limited to said patents; refer to FIGS. 1 to 16;

20. Claim 20 is an independent claim as we start to point out the industries that can be implemented to great efficiencies and great protection with the power energy distribution system and the patents listed in the specification but not limited to, and how they perform; first of all shielding and the use of energy and its implication is the subject of this invention, heat, light, sound, differentials and what causes all different types of environmental and control problems is this independent claim being able to control these different types of environmental and energy problems and security to secure these problems enabling energy savings and cost savings refer to FIGS. 1 to 16;

21. Claim 21 is an independent claim, here we are taking new claims and the list of patents listed in the specification but not limited to, pertaining to panels isolated from outer to inner shielding from frequency interference wherein we do not conduct from one side to the other side and has an isolator in the center wherein that we can use electrical energy to energize it, we can use energy to create frequencies for sending and shielding and scrambling; we can isolate each individual conductor so in that it is fire resistant and protected, we have an air space on either side of the center core wherein that we can perform energy using that space in the panel for heating and air conditioning or a liquid that should there be a fire or hazardous situation it is an intelligent panel that provides all of the utility to maintain an environment on one side from the other; this can operate these panels to implement the intelligence of the panel to detect and transmit to a central processor and then automatically release whatever protection is required to maintain the integrity and the performance of the panel with the power energy distribution system which enables energy savings and cost savings, this claim is just now describing an application of one of the patents listed in the specification but not limited to, which the system can be used very efficiently and afford maximum protection for differentials in temperature controlling the use of energy to maintain an environment; refer to FIGS. 1 to 16;

22. Claim 22, as in claim 21, now we are claiming the system described in the independent claim 21 in the use of the patented products listed in the specification but not limited to, and their use for the housing industry, a complete house can be constructed with these panels and operated with the use of the power energy distribution system; a complete building, roofs, ceilings, floors, walls, openings, sidewalks all using this power energy distribution system enabling energy savings and cost savings with these assets; refer to FIGS. 1 to 16;

23. Claim 23, as in claim 21 is for use in commercial buildings, such as hospitals, schools, office buildings, high rise buildings, multiple storage buildings, different exposures to the different environmental conditions; with this power energy distribution system providing the control of energy, detecting and directing the energy to each of its requirements to provide the environment for the facility wherein for different operations for operating rooms, different applications for office rooms, maintaining and controlling radiation, isolating frequencies and providing protection for individuals and also providing the least cost of energy to provide all of these features in this claim along with the patented product and the invention to implement it as listed in the specification, but not limited to; refer to FIGS. 1 to 16;

24. Claim 24, as in claim 21 is the use of the power energy distribution system for controlling energy in manufacturing a product and maintaining an environment that allows a more efficient manufacturing of that product without the hazards that are present in the manufacturing procedure; when we shield from frequencies, when we shield from heat, and when we shield from differentials in high temperatures, from one system to another, these panels in the patents listed in the specification, but not limited to, panels place a high value to the efficiency, ability and safety of manufacturing a product; refer to FIGS. 1 to 16;

25. Claim 25 as in claim 21, is the use of the power energy distribution system for control of energy in the operations of transportation of all types of vehicles, automobiles, buses, trains, trucks, ships, can be moving vehicles shielded environmentally provide temperature, humidity,

26. Claim 26 as claimed in claim 21 is the claim is the claim for controlling the use of energy for aerospace and aircraft construction and operations is a great part of this invention's capability to operate and maintain the integrity of the aerospace industry, of the environmental control of the internal operating parts of the aircraft; the panels that are different laminations to which one side is isolated from the other and is controlled with the power energy distribution system; the power energy distribution system can control the use of energy to maintain the integrity of the operations of the aircraft, the entire structure, such as the main fuselage, the wing structure and vertical stabilizer; the different panels that have been patented, laminations for both weight resistivity, the ability to maintain the integrity of the cabin and cockpit, from all different types of impact, all different types of fire, gases and environmental conditions of smoke, hazards in the entire cabin and cockpit including storage areas using the technology of the panels listed in the specifications, not limited to, for operations and maintenance of aircrafts; refer to FIGS. 1 to 16;

27. Claim 27 as in claim 21 we start now to use the power energy distribution system to control the use of energy for maintaining engine cowlings, flaps, landing struts, landing gear, controlling parts of the aircraft which is exposed to de-icing, icing, and other hazards, see patent in specifications but not limited to; the power energy distribution system will be monitoring wherein every part of the plane will be encased in this technology and maintained and prevent accidents, impact resistance, fire protection inside the cockpit wherein that the air circulation and the air circulation to the entire structure of the aircraft will be maintained for a minimum of energy required, the panels, their configuration and their shielding where electronic equipment in the aircraft, signaling and testing of the aircraft from any point in the panel or any environmental change; it is sophisticated and so viable on the facts of engineering and the ability to implement it,; refer to FIGS. 1 to 16;

28. Claim 28, an independent claim wherein we describe in detail the power energy distribution system that the system can control and maintain; for other uses in the aerospace industry, we are looking at the structure and protection of the skin for space vehicles, for solar conductivity for in-fra-red thermal detection to signal the microprocessor to send the correction of environment from one location to another; this is a very simple system of taking the patented products from the patents listed in the specification but not limited to, and implementing them with their protection and security of the space ship, rocket or anything that moves in space and requires a control system; with the solar system detector and directing energy from the sun and focusing it in the power energy distribution system to maintain energy in the power energy distribution system operation and integrity and with all of the features of the panels that can be implemented instantaneously to provide the use of energy whatever exposure the object can be exposed to; refer to FIGS. 1 to 16;

29. Claim 29 as in claim 28, looking after the flight safety hazards that we are faced with, the power energy distribution system can control energy and maintain through the structure of the craft and the systems that operate the aircraft flaps, landing gear the fuel lines, communications lines, all of these systems can be isolated and channeled through the security, the ability to maintain the safety and energy to energize, to detect the problem and to provide the backup system to it; refer to FIGS. 1 to 16;

30. Claim 30 as in claim 28 now we are opening the ability of the power energy distribution system and the patents listed in the specification but not limited to, for all different types of applications segregating these claims for a specific on a vehicle, aircraft, aerospace and the testing systems of the safety of flight, for deicing, for any fire intrusion, and also extinguishing the fire in a panel, also to maintain the temperature and air distribution in the panel and deice on the outside and maintain the integrity if there is any failure within the panel system. the laminated panel system will be detected immediately; an antidote will come to provide security until the problem can be rectified; refer to FIGS. 1 to 16;

31. Claim 31, this independent claim that all of the claims and all of the patents in the specification, but not limited to, includes any and all composites using a path of energy of isolation from one composite to another and with the use of the power energy distribution system, this will be achieved, but this claim identifies the use and requirement of this invention and that the reader fully understands this application of the invention to those existing patents but not limited to, for all uses of this application that will be involved in the use of the power energy distribution system; refer to FIGS. 1 to 16;
